(19) United States
(12) Patent Application Publication
(10) Pub. No.: US 2014/0072419 A1
(43) Pub. Date: Mar. 13, 2014

(54) ROTARY MACHINES AND METHODS OF ASSEMBLING

(71) Applicants: Manish Joshi, Bangalore (IN); David Orus Fitts, Ballston Spa, NY (US); Robert Edward Deallenbach, Flat Rock, NC (US)

(72) Inventors: Manish Joshi, Bangalore (IN); David Orus Fitts, Ballston Spa, NY (US); Robert Edward Deallenbach, Flat Rock, NC (US)

(21) Appl. No.: 13/614,297

(22) Filed: Sep. 13, 2012

(51) Int. Cl. F01D 9/04; B23P 15/00; B05B 1/00

(52) U.S. Cl. 415/182.1; 239/589; 29/888.025

(57) ABSTRACT

A nozzle assembly is provided. The nozzle assembly includes at least one stationary nozzle. An outer ring having a predefined shape includes at least one groove defined therein and the groove is configured to receive at least a portion of the stationary nozzle therein. A coupling portion is formed integrally with the stationary nozzle or the outer ring such that the coupling portion extends outwardly therefrom. An attachment member is coupled to the coupling portion to facilitate substantially restricting movement of the stationary nozzle when the outer ring is substantially distorted.

### BACKGROUND OF THE INVENTION

The field of the invention relates generally to rotary machines and, more particularly, to nozzle assemblies for use in a rotary machine.

At least some rotary machines, such as known steam turbine engines, include a defined steam path. The path includes, in serial-flow relationship, a steam inlet, a turbine, and a steam outlet. Many of known steam turbine engines include stationary nozzles that channel a flow of steam towards rotating buckets or turbine blades. The nozzles and rotating blades are coupled to a rotatable member, such as a rotor. At least some known stationary nozzles include a plurality of airfoils and/or dovetailed end portions that channel the steam flow downstream. Each nozzle, in conjunction with an associated row of rotating blades, is sometimes referred to as a turbine stage and most known steam turbine engines include a plurality of stages.

Known steam turbine engines may include an annular outer ring or blinglet ring that substantially circumscribes the rotor. The outer ring has a predefined shape and may include at least one groove that receives, for example, at least one stationary nozzle therein. Having the nozzle coupled within the groove of the outer ring enables the nozzle to remain stationary during turbine engine operation. As steam flows through each stage, the pressure drops and various forces are applied to each nozzle and rotating blade. When forces, such as radial forces, are applied to the dovetail portion of a stationary nozzle, the forces are induced to the outer ring. Such forces, along with the substantially high temperatures of the steam flow may distort the outer ring. For example, over time, the outer ring may bend or even break. As a result, the nozzle may detach from the outer ring. When the nozzle is detached from the outer ring, the nozzle may move, for example, as the rotor rotates. Continued operation of a steam turbine engine with a damaged outer ring and/or a detached nozzle may cause damage to other components and/or may lead to a premature failure of the steam turbine engine.

To prevent distortion of the outer ring, some known steam turbine engines have been modified. For example, relatively thicker outer rings may be used with the same known steam turbine engines. As steam flows through each stage of such turbine engines, the relatively thicker outer ring may be able to withstand the forces and the flow temperatures. As such, distortion of the predefined shape of the outer ring may be prevented and the nozzle may remain coupled to the outer ring. However, manufacturing relatively thicker outer rings can be expensive and time-consuming, as additional materials are required.

### BRIEF DESCRIPTION OF THE INVENTION

In one embodiment, a nozzle assembly is provided. The nozzle assembly includes at least one stationary nozzle. An outer ring having a predefined shape includes at least one groove defined therein and the groove is configured to receive at least a portion of the stationary nozzle therein. A coupling portion is formed integrally with the stationary nozzle or the outer ring such that the coupling portion extends outwardly therefrom. An attachment member is coupled to the coupling portion to facilitate substantially restricting movement of the stationary nozzle when the outer ring is substantially distorted.

In another embodiment, a rotary machine is provided. The rotary machine includes a rotor and at least one nozzle assembly coupled to the rotor. The nozzle assembly includes at least one stationary nozzle extending radially outwardly from the rotor. An outer ring having a predefined shape substantially circumscribes the rotor. The outer ring includes at least one groove defined therein and the groove is configured to receive at least a portion of the stationary nozzle therein. A coupling portion is formed integrally with the stationary nozzle or the outer ring such that the coupling portion extends outwardly therefrom. An attachment member is coupled to the coupling portion to facilitate substantially restricting movement of the stationary nozzle when the outer ring is substantially distorted.

In another embodiment, a method of assembling a rotary machine is provided. At least one stationary nozzle is coupled to a rotor such that the stationary nozzle extends radially outwardly from a rotor. An outer ring having a predefined shape is coupled to the rotor such that the outer ring substantially circumscribes the rotor. The outer ring includes at least one groove defined therein and the groove is configured to receive at least a portion of the stationary nozzle therein. A coupling portion is formed integrally with the stationary nozzle or the outer ring such that the coupling portion extends outwardly therefrom. An attachment member is coupled to the coupling portion to facilitate substantially restricting movement of the stationary nozzle when the outer ring is substantially distorted.

### BRIEF DESCRIPTION OF THE DRAWINGS

FIG. 1 is a cross-sectional schematic view of an exemplary opposed-flow steam turbine engine;

FIG. 2 is a cross-sectional schematic view of a high pressure (HP) section used with the steam turbine engine shown in FIG. 1;

FIG. 3 is a cross-sectional schematic view of a portion of an exemplary nozzle assembly that may be used with the HP section of the steam turbine engine shown in FIG. 2 and taken along area 3;

FIG. 4 is a cross-sectional schematic view of a portion of an alternative nozzle assembly that may be used with the HP section of the steam turbine engine shown in FIG. 2 and taken along area 3;

FIG. 5 is a cross-sectional schematic view of a portion of another alternative nozzle assembly that may be used with the HP section of the steam turbine engine shown in FIG. 2 and taken along area 3; and

FIG. 6 is a cross-sectional schematic view of a portion of another alternative nozzle assembly that may be used with the HP section of the steam turbine engine shown in FIG. 2 and taken along area 3.

### DETAILED DESCRIPTION OF THE INVENTION

The exemplary systems and methods described herein overcome disadvantages associated with at least some known rotary machines by enabling a nozzle coupled within the rotary machine to remain substantially stationary during operation of the associated rotary machine. More specifically, the embodiments described herein provide a nozzle assembly that includes a coupling portion and an attachment member that couple a stationary nozzle to an outer ring or blinglet ring such that movement of the nozzle is substantially reduced when the outer ring is distorted during operation of the rotary machine.

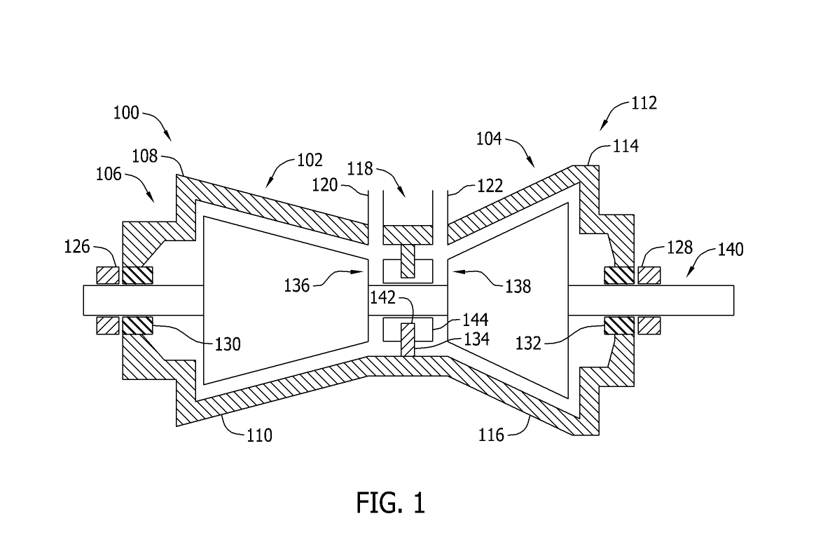

FIG. 1 illustrates a cross-sectional schematic view of an exemplary rotary machine 100. More specifically, in the exemplary embodiment, rotary machine 100 is an opposed-flow steam turbine engine 100 that includes a high pressure (HP) section 102 and an intermediate pressure (IP) section 104. While steam turbine engine 100 is an opposed-flow HP and IP steam turbine engine, any other steam turbine engine may be used including, but not being limited to, a low pressure turbine. In addition, the present invention is not limited to only being used with opposed-flow steam turbine engines, but rather the invention may be used with any turbine engine configuration including, but not limited to, single-flow and double-flow steam turbine engines. Moreover, although rotary machine 100 is illustrated as being a steam turbine engine, it should be noted that the present disclosure is not limited to any one particular rotary machine and one of ordinary skill in the art should appreciate that the present disclosure may be used with any rotary machine in any suitable configuration that enables the systems and methods described herein.

In the exemplary embodiment, an HP shell or casing 106 is divided generally axially into respective upper and lower half sections 108 and 110. Similarly, an IP shell 112 is divided generally axially into respective upper and lower half sections 114 and 116. In the exemplary embodiment, shells 106 and 108 are inner casings. Alternatively, shells 106 and 108 may be outer casings. A central section 118 extends between sections 102 and 104, and includes a high pressure steam inlet 120 and an intermediate pressure steam inlet 122. Within casings 106 and 112, HP section 102 and IP section 104, respectively, are oriented in a single bearing span that is supported by journal bearings 126 and 128. Steam seal assemblies 130 and 132 are coupled inboard of each respective journal bearing 126 and 128.

An annular section divider 134 extends radially inwardly from central section 118 towards a rotatable element 140. In the exemplary embodiment, rotatable element 140 is a rotor that extends between HP section 102 and IP section 104. More specifically, divider 134 circumscribes a portion of rotor 140 between a first HP section inlet nozzle 136 and a first IP section inlet nozzle 138. Divider 134 is at least partially inserted into a channel 142 defined in a packing casing 144. More specifically, in the exemplary embodiment, channel 142 is C-shaped channel 142 and extends substantially radially into packing casing 144 and around an outer circumference of packing casing 144 such that a center opening (not shown) of channel 142 faces radially outwardly.

During operation, high pressure steam inlet 120 receives high pressure and high temperature steam from a steam source, such as a power boiler (not shown). Steam is channeled through HP section 102 from inlet nozzle 136, wherein the steam induces rotation of rotor 140. In the exemplary embodiment, the steam contacts a plurality stationary nozzles (not shown in FIG. 1) and rotatable turbine blades or buckets (not shown in FIG. 1) that are coupled to rotor 140. In the exemplary embodiment, the stationary nozzles channel steam towards the rotatable blades. The steam exits HP section 102 and is returned to the boiler, wherein the steam is reheated. Reheated steam is then routed to IP steam inlet 122 and returned to IP section 104 at a lower pressure than steam entering HP section 102, but at a temperature that is approximately equal to the temperature of steam entering HP section 102. Work is extracted from the steam in IP section 104 in a manner substantially similar to that used for HP section 102. Accordingly, an operating pressure within HP section 102 is higher than an operating pressure within IP section 104, such that steam within HP section 102 tends to flow towards IP section 104 through leakage paths (not shown) defined between HP section 102 and IP section 104.

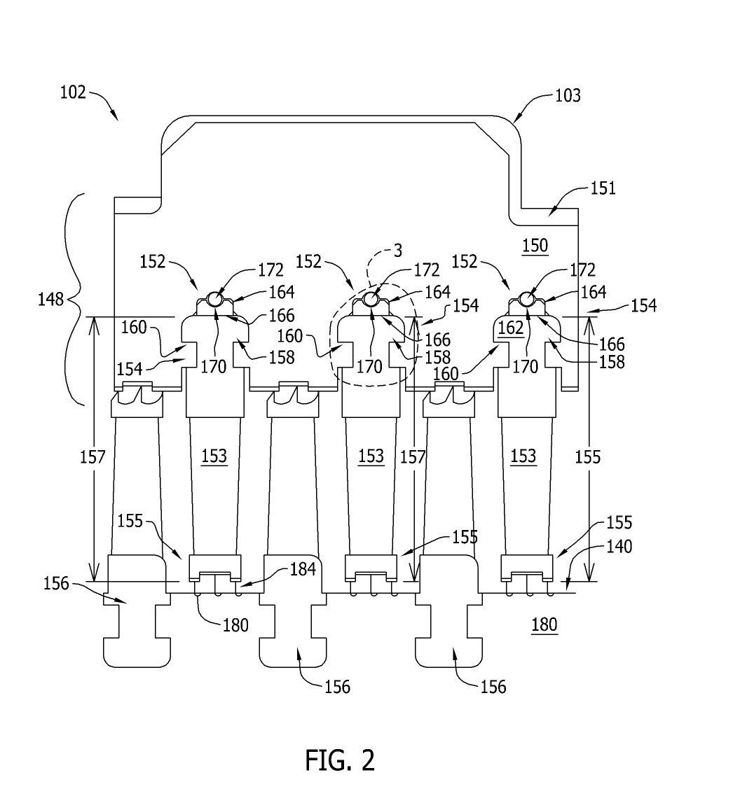

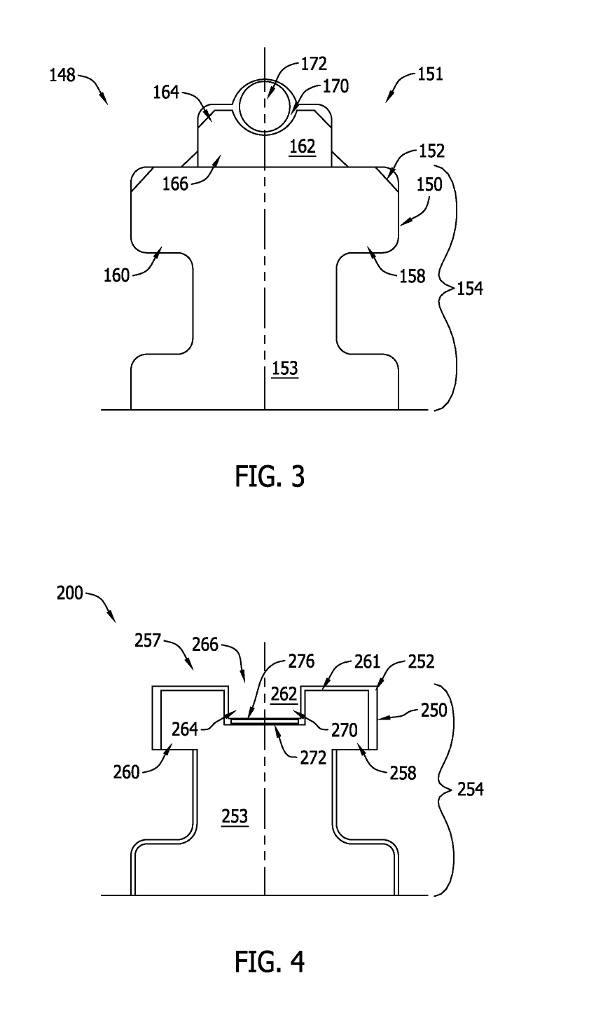

FIG. 2 is a cross-sectional schematic view of HP section 102 of steam turbine engine 100 (shown in FIG. 1). FIG. 3 is a cross-sectional schematic view of a portion of an exemplary nozzle assembly 148 that may be used with HP section 102 of steam turbine engine 100 and taken along area 3 (shown in FIG. 2). In the exemplary embodiment, HP section 102 includes an upper half casing 103 that is coupled to a lower half casing (not shown) when engine 100 is fully assembled. HP section 102 includes at least one nozzle assembly 148 that includes a substantially annular outer or blinglet ring 150 that substantially circumscribes rotor 140. Further, in the exemplary embodiment, a top half 151 of ring 150 is mated against radially inner surfaces of upper half casing 103 such that ring top half 151 acts as a radial inward extension of casing 103. Such mating facilitates maintaining top half 151 of ring 150 in a substantially fixed position with respect to rotor 140. Top half 151 of ring 150 also includes at least one groove 152 defined therein.

Moreover, in the exemplary embodiment, nozzle assembly 148 includes at least one stationary nozzle 153. Groove 152 is sized and oriented to receive at least a portion of nozzle 153 therein. More specifically, in the exemplary embodiment, nozzle assembly 148 includes three grooves 152 defined within ring top half 151, and each groove 152 is sized and oriented to receive one nozzle 153 therein. In the exemplary embodiment, each nozzle 153 includes a first end portion 154, and a second end portion 155 that is positioned a predefined distance 157 from first end portion 154. In the exemplary embodiment, each first end portion 154 is dovetailed and includes a first hook portion 158 and a second hook portion 160. Each groove 152 is keyed to receive first end portion 154 therein. A bottom half (not shown) of ring 150 is coupled to the lower half casing and receives nozzles 153 in a manner similar to ring top half 150. HP section 102 also includes a plurality of rotatable turbine blades, or bucket assemblies 156 that are securely coupled to rotor 140.

In the exemplary embodiment, a coupling portion 162 extends from each nozzle first end portion 154. More specifically, in the exemplary embodiment, each coupling portion 162 is formed integrally with respective nozzle first end portion 154 such that nozzle 153 and coupling portion 162 are a unitary component. Coupling portion 162 may be formed with nozzle 153 via a variety of known manufacturing processes known in the art, such as, but not limited to, molding process, drawing process or a machining process. One or more types of materials may be used to fabricate coupling portion 162 and/or nozzle 153 with the materials selected based on suitability for one or more manufacturing techniques, dimensional stability, cost, moldability, workability, rigidity, and/or other characteristic of the material(s). For example, coupling portion 162 and/or nozzle 153 may be fabricated from a metal, such as an alloy steel and/or a nickel based material.

In the exemplary embodiment, each coupling portion 162 includes a first end 164 and a second end 166. Coupling portion second end 166 is integrally formed with, and is positioned adjacent to, nozzle first end portion 154. Coupling portion first end 164 is positioned adjacent to groove 152. Coupling portion first end 164, in the exemplary embodiment, includes an arcuate groove 170 defined therein. Groove 170 is sized and oriented to receive an attachment member 172 therein. In the exemplary embodiment, one attachment member 172 is positioned within each groove 170. In the exemplary embodiment, attachment member 172 is a pin or bolt that couples at least a portion of nozzle first end portion 154 to at least a portion of ring groove 152 such that nozzle 153 and outer ring 150 are securely coupled together.

Moreover, in the exemplary embodiment, rotor 140 includes a rotor surface 180 that includes a plurality of substantially annular rotor grooves 182 formed therein. At least one substantially arcuate sealing strip 184 is securely coupled within each rotor groove 182. In the exemplary embodiment, nozzle second end portion 155 is positioned adjacent to sealing strips 184. In the exemplary embodiment, sealing strips 184 substantially reduce an amount of fluid flowpath leakage that may occur between rotor 104 and casing 103.

During operation, steam enters section 102 via HP section steam inlet 122 (shown in FIG. 1) and is channeled through section 102, as illustrated by arrows 190. Inlet nozzle 136 (shown in FIG. 1) and nozzles 153 channel steam to bucket assemblies 156. As steam is channeled to nozzles 153 and to bucket assemblies 156, forces are induced to nozzles 153 and bucket assemblies 156. Moreover, the pressure drops within section 102 and various forces, such as radial forces, are induced to nozzles 153 and bucket assemblies 156. When the forces are applied to end portion 154 of nozzle 153, the forces are transferred to ring top half 151 from end portion 154. Such forces, along with the substantially high steam flow temperatures within section 102, may cause distortion of ring 150. More specifically, a portion of ring top half 151 may bend or even break.

When ring 150 becomes distorted, coupling portion 162 and attachment member 172 enable nozzle 153 to remain securely coupled to ring top half 151. More specifically, coupling portion 162 maintains the relative position of attachment member 172 within arcuate groove 170. As such, attachment member 172 does not move even when ring 150 becomes distorted. Moreover, since attachment member 172 remains in place, nozzle 153 remains securely coupled to ring 150. Accordingly, movement of nozzle 153 is substantially restricted even when ring 150 is substantially distorted.

FIG. 4 is a cross-sectional schematic view of a portion of an alternative nozzle assembly 200 that may be used with HP section 102 (shown in FIG. 2) of steam turbine engine 100 (shown in FIG. 1) and taken along area 3 (shown in FIG. 2) in place of nozzle assembly 148 (shown in FIGS. 2 and 3). In the exemplary embodiment, nozzle assembly 200 includes a substantially annular outer or blinglet ring 250 that substantially circumscribes rotor 140 (shown in FIGS. 1 and 2). Moreover, in the exemplary embodiment, a top half 251 of ring 250 mates to radially inner surfaces of the upper half casing 103 (shown in FIG. 2) such that ring top half 250 acts as a radial inward extension of casing 103. Such mating facilitates maintaining top half 251 of ring 250 in a substantially fixed position with respect to rotatable element 140. Top half 251 of ring 250 also includes at least one groove 252 defined therein.

Moreover, in the exemplary embodiment, nozzle assembly 200 includes at least one stationary nozzle 253. Groove 252 is sized and oriented to receive at least a portion of nozzle 253 therein. In the exemplary embodiment, nozzle 253 includes an end portion 254. In the exemplary embodiment, end portion 254 is dovetailed and includes a first hook portion 258 and a second hook portion 260. Nozzle end portion 254 also includes a groove 261 defined therein between the first hook portion 258 and second hook portion 260. In addition, each ring groove 252 is sized and oriented to receive nozzle first end portion 254 therein.

In the exemplary embodiment, a coupling portion 262 extends from ring 250. More specifically, in the exemplary embodiment, coupling portion 262 extends from ring groove 252 and is positioned at least partially within nozzle groove 261. Coupling portion 262 is formed integrally with ring 250 such that coupling portion 262 and ring 250 are a unitary component. Coupling portion 262 may be formed with ring 250 via a variety of known manufacturing processes known in the art, such as, but not limited to, molding process, drawing process, and/or a machining process. One or more types of materials may be used to fabricate coupling portion 262 and/or ring 250 with the materials selected based on suitability for one or more manufacturing techniques, dimensional stability, cost, moldability, workability, rigidity, and/or other characteristic of the material(s). For example, coupling portion 262 and/or ring 250 may be fabricated from a metal, such as a steel alloy material and/or a nickel-based material.

In the exemplary embodiment, coupling portion 262 includes a first end 264 and a second end 266. Second end 266 is formed integrally with, and is positioned adjacent to, ring groove 252. Coupling portion first end 264 is positioned adjacent to nozzle groove 261. Coupling portion first end 264, in the exemplary embodiment, has a substantially planar surface 270. Moreover, nozzle groove 261 has a substantially planar surface 272. At attachment member 276 is positioned between each surface 270 and 272. In the exemplary embodiment, attachment member 276 is a substantially thin plate that is coupled to nozzle groove 261 and coupling portion first end 264. Further, attachment member 276 couples at least a portion of nozzle first end portion 254 to at least a portion of ring groove 252 such that nozzle 253 and outer ring 250 are securely coupled together.

During operation, steam entering section 102 via HP section steam inlet 122 (shown in FIG. 1) is channeled through section 102 as illustrated by arrows 190 (shown in FIG. 2). As steam is channeled to nozzles 253, forces are being applied to nozzle 253. Moreover, as the operating pressure drops within section 102 and various forces, such as radial forces, are induced to nozzle 253. When the forces are applied to nozzle end portion 254, the forces are transferred to ring top half 251 from end portion 254. Such forces, along with the substantially high steam flow temperatures within section 102, cause a distortion of ring 250. More specifically, over time, a portion of ring top half 251 may bend or even break.

When ring 250 becomes distorted, coupling portion 262 and attachment member 276 enable nozzle 253 to remain coupled to outer ring top half 251. More specifically, coupling portion 262 maintains the relative position of attachment member 276 between coupling portion first end 264 and nozzle groove 261. As such, attachment member 276 does not move even when ring 250 becomes distorted and nozzle 253 remains securely coupled to ring 250. Accordingly, the movement of nozzle 253 is substantially restricted even when ring 250 is substantially distorted.

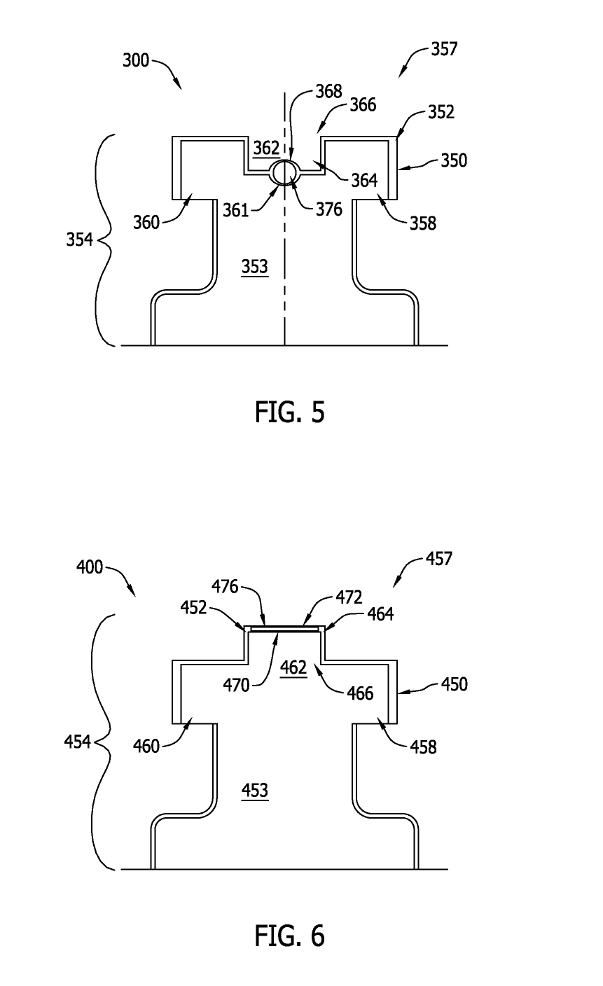

FIG. 5 is a cross-sectional schematic view of a portion of an alternative nozzle assembly 300 that may be used with HP section 102 (shown in FIG. 2) of steam turbine engine 100 (shown in FIG. 1) and taken along area 3 (shown in FIG. 2) in place of nozzle assembly 148 (shown in FIGS. 2 and 3). In the exemplary embodiment, nozzle assembly 300 includes a substantially annular outer or blinglet ring 350 substantially circumscribing rotatable element 140 (shown in FIGS. 1 and 2). Further, in the exemplary embodiment, a top half 351 of ring 350 mates to radially inner surfaces of the upper half casing 103 (shown in FIG. 2) such that ring top half 350 acts as a radial inward extension of casing 103. Such mating facilitates maintaining top half 351 of ring 350 in a substantially fixed position with respect to rotor 140. Top half 351 of ring 350 also includes at least one groove 352.

Moreover, in the exemplary embodiment, nozzle assembly 300 includes at least one stationary nozzle 353 that groove 352 is configured to receive. In the exemplary embodiment, each nozzle 353 includes an end portion 354 that is dovetailed with a first hook portion 358 and a second hook portion 360. Nozzle end portion 354 also includes a substantially arcuate groove 361 positioned between first hook portion 358 and second hook portion 360. In addition, each ring groove 352 is configured to receive nozzle first end portion 354 therein. A bottom half (not shown) of ring 350 is coupled to the lower half casing and receives nozzles 353 in a manner similar to ring top half 350.

In the exemplary embodiment, a coupling portion 362 extends from ring 350. More specifically, in the exemplary embodiment, coupling portion 362 extends from ring groove 352. Coupling portion 362 is formed integrally with ring 350 such that coupling portion 362 and ring 350 are a unitary component. Coupling portion 362 may be formed with ring 350 via a variety of known manufacturing processes known in the art, such as, but not limited to, molding process, drawing process, and/or a machining process. One or more types of materials may be used to fabricate coupling portion 362 and/or ring 350 with the materials selected based on suitability for one or more manufacturing techniques, dimensional stability, cost, moldability, workability, rigidity, and/or other characteristic of the material(s). For example, coupling portion 362 and/or ring 350 may be fabricated from a metal, such as a steel alloy material and/or a nickel-based material.

In the exemplary embodiment, each coupling portion 362 has a first end 364 and a second end 366, wherein coupling portion second end 366 is integrally formed with and positioned adjacent to ring groove 352. Coupling portion first end 364, in the exemplary embodiment, has a substantially arcuate groove 368 defined therein. Coupling portion groove 368 is positioned and aligned directly above nozzle groove 361. Positioned within each groove 361 and 368 is an attachment member 376. In the exemplary embodiment, attachment member 376 is a pin or bolt. Further, attachment member 376 is configured to couple at least a portion of nozzle first end portion 354 to at least a portion of ring groove 352 such that nozzle 353 and outer ring 350 are securely coupled together.

During operation, steam enters section 102 via HP section steam inlet 122 (shown in FIG. 1) and is channeled through section 102 as illustrated by arrows 190 (shown in FIG. 2). As steam is being channeled to nozzles 353, forces are being applied to nozzle 353. Moreover, the pressure drops within section 102 and various forces, such as radial forces, are induced to nozzle 353. When the forces are induced to nozzle end portion 354, the forces are transferred to ring top half 351 from end portion 354. Such forces, along with the substantially high steam flow temperatures within section 102, cause a distortion of ring 350. More specifically, a portion of ring top half 351 may bend or even break.

When ring 350 becomes distorted, coupling portion 362 and attachment member 376 enable nozzle 353 to remain securely coupled to outer ring top half 351. More specifically, coupling portion 362 facilitates maintaining the attachment member 376 to be positioned within nozzle groove 361 and coupling portion groove 368. As such, attachment member 376 does not move even when ring 350 becomes distorted. Moreover, since the attachment member 376 remains positioned within grooves 361 and 368, nozzle 353 is enabled to remain securely coupled to ring 350. Accordingly, movement of nozzle 353 is substantially restricted even when ring 350 is substantially distorted.

FIG. 6 is a cross-sectional schematic view of a portion of an alternative nozzle assembly 400 that may be used with HP section 102 (shown in FIG. 2) of steam turbine engine 100 (shown in FIG. 1) and taken along area 3 (shown in FIG. 2) in place of nozzle assembly 148 (shown in FIGS. 2 and 3). In the exemplary embodiment, nozzle assembly 400 includes a substantially annular outer or blinglet ring 450 substantially circumscribing rotor 140 (shown in FIGS. 1 and 2). Further, in the exemplary embodiment, a top half 451 of ring 450 mates to radially inner surfaces of the upper half casing 103 (shown in FIG. 2) such that ring top half 450 acts as a radial inward extension of casing 103. Such mating facilitates maintaining top half 451 of ring 450 in a substantially fixed position with respect to rotor 140. Top half 451 of ring 450 also includes at least one groove 452.

Moreover, in the exemplary embodiment, nozzle assembly 400 includes at least one stationary nozzle 453 that groove 452 is configured to receive. In the exemplary embodiment, each nozzle 453 includes an end portion 454 that is dovetailed and includes a first hook portion 458 and a second hook portion 460. In addition, each ring groove 452 is configured to receive nozzle first end portion 454 therein. A bottom half (not shown) of ring 450 is coupled to the lower half casing and receives nozzles 453 in a manner similar to ring top half 450.

In the exemplary embodiment, a coupling portion 462 extends from nozzle 453. More specifically, in the exemplary embodiment, coupling portion 462 extends from nozzle first end portion 457. Coupling portion 462 is formed integrally with nozzle 453 such that coupling portion 462 and nozzle 453 are a unitary component. Coupling portion 462 may be formed with nozzle 453 via a variety of known manufacturing processes known in the art, such as, but not limited to, molding process, drawing process, and/or a machining process. One or more types of materials may be used to fabricate coupling portion 462 and/or nozzle 453 with the materials selected based on suitability for one or more manufacturing techniques, dimensional stability, cost, moldability, workability, rigidity, and/or other characteristic of the material(s). For example, coupling portion 462 and/or nozzle 453 may be fabricated from a metal, such as a steel alloy material and/or a nickel-based material.

In the exemplary embodiment, coupling portion 462 has a first end 464 and a second end 466, wherein coupling portion second end 466 is integrally formed with, and positioned adjacent to, nozzle first end portion 457. Coupling portion first end 464 is positioned adjacent to ring 450. Coupling portion first end 464, in the exemplary embodiment, has a substantially planar surface 470. Moreover, ring groove 452 has a substantially planar surface 472. Positioned between each surface 470 and 472 is an attachment member 476. In the exemplary embodiment, attachment member 476 is a substantially thin plate that is coupled to ring groove 452 and coupling portion first end 464. Further, attachment member 476 is configured to couple at least a portion of nozzle first end portion 454 to at least a portion of ring groove 452 such that nozzle 453 and outer ring 450 are securely coupled together.

During operation, steam enters section 102 via HP section steam inlet 122 (shown in FIG. 1) and is channeled through section 102 as illustrated by arrows 190 (shown in FIG. 2). As steam is being channeled to nozzle 453, forces are being applied to nozzle 453. Moreover, the pressure drops within section 102 and various forces, such as radial forces, are induced to nozzle 453. When the forces are induced to nozzle end portion 454, the forces are transferred to ring top half 451 from end portion 454. Such forces, along with the substantially high steam flow temperatures within section 102, cause a distortion of ring 450. More specifically, a portion of ring top half 451 may bend or even break.

When ring 450 becomes distorted, coupling portion 462 and attachment member 476 enable nozzle 453 to remain securely coupled to outer ring top half 451. More specifically, coupling portion 462 maintains the position of attachment member 476 between coupling portion first end 464 and ring groove 452. As such, attachment member 476 does not move even when ring 450 becomes distorted. Moreover, nozzle 453 remains coupled to ring 450. Accordingly, movement of nozzle 453 is substantially restricted even when ring 450 is substantially distorted.

As compared to known rotary machines, the embodiments described herein provide a rotary machine that enables a nozzle coupled within the rotary machine to remain substantially stationary during operation of the rotary machine. More specifically, the embodiments described herein provide a nozzle assembly that includes at least one stationary nozzle and an outer ring that includes at least one groove defined therein. The groove is configured to receive at least a portion of the stationary nozzle therein. A coupling portion is formed integrally with the stationary nozzle or the outer ring such that the coupling portion extends outwardly therefrom. An attachment member is coupled to the coupling portion to facilitate substantially restricting movement of the stationary nozzle when the outer ring is substantially distorted.

Exemplary embodiments of the systems and methods are described above in detail. The systems and methods are not limited to the specific embodiments described herein, but rather, components of the systems and/or steps of the methods may be utilized independently and separately from other components and/or steps described herein. For example, the systems may also be used in combination with other systems and methods, and is not limited to practice with only the systems as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A nozzle assembly comprising:
at least one stationary nozzle;
an outer ring having a predefined shape, said outer ring comprises at least one groove defined therein, said at least one outer ring groove is configured to receive at least a portion of said at least one stationary nozzle therein;
a coupling portion formed integrally with one of said at least one stationary nozzle and said outer ring such that said coupling portion extends outwardly therefrom; and
an attachment member coupled to said coupling portion to facilitate substantially restricting movement of said at least one stationary nozzle when said outer ring is substantially distorted.

2. A nozzle assembly in accordance with claim 1, wherein said attachment member comprises a pin configured to fixedly secure said at least one stationary nozzle to said outer ring.

3. A nozzle assembly in accordance with claim 2, wherein said coupling portion comprises an end portion comprising a substantially arcuate groove defined therein, said groove configured to receive said pin therein.

4. A nozzle assembly in accordance with claim 2, wherein said at least one stationary nozzle comprises an end portion coupled within said at least one outer ring groove, said end portion comprises a substantially arcuate groove defined therein and configured to receive said pin therein.

5. A nozzle assembly in accordance with claim 1, wherein said attachment member comprises a plate extending between said at least one stationary nozzle and said outer ring.

6. A nozzle assembly in accordance with claim 1, wherein said at least one stationary nozzle comprises an end portion coupled within said at least one outer ring groove, said end portion comprises a dovetailed end portion.

7. A nozzle assembly in accordance with claim 1, wherein said at least one outer ring groove is keyed.

8. A nozzle assembly in accordance with claim 1, wherein said coupling portion is fabricated from an alloy steel.

9. A rotary machine comprising:
a rotor; and
at least one nozzle assembly coupled to said rotor, said at least one nozzle assembly comprising:
at least one stationary nozzle extending radially outwardly from said rotor;
an outer ring having a predefined shape and said outer ring substantially circumscribes said rotor, wherein said outer ring comprises at least one groove defined therein, said at least one outer ring groove is configured to receive at least a portion of said at least one stationary nozzle therein;
a coupling portion formed integrally with one of said at least one stationary nozzle and said outer ring such that said coupling portion extends outwardly therefrom; and
an attachment member coupled to said coupling portion to facilitate substantially restricting movement of said at least one stationary nozzle when said outer ring is substantially distorted.

10. A rotary machine in accordance with claim 9, wherein said attachment member comprises a pin configured to fixedly secure said at least one stationary nozzle to said outer ring.

11. A rotary machine in accordance with claim 10, wherein said coupling portion comprises an end portion comprising a substantially arcuate groove defined therein, said groove is configured to receive said pin therein.

12. A rotary machine in accordance with claim 10, wherein said at least one stationary nozzle comprises an end portion coupled within said at least one outer ring groove, said end portion comprises a substantially arcuate groove defined therein and configured to receive said pin therein.

13. A rotary machine in accordance with claim 9, wherein said attachment member comprises a plate extending between said at least one stationary nozzle and said outer ring.

14. A rotary machine in accordance with claim 9, wherein said at least one stationary nozzle comprises an end portion coupled within said at least one outer ring groove, said end portion comprises a dovetailed end portion.

15. A rotary machine in accordance with claim 9, wherein said at least one outer ring groove comprises a dovetailed groove.

16. A rotary machine in accordance with claim 9, wherein said coupling portion is fabricated from an alloy steel.

17. A method of assembling a rotary machine, said method comprising:
coupling at least one stationary nozzle to a rotor such that the at least one stationary nozzle extends radially outwardly from a rotor;
coupling an outer ring having a predefined shape to the rotor such that the outer ring substantially circumscribes the rotor, the outer ring includes at least one groove defined therein, the at least one groove configured to receive at least a portion of the at least one stationary nozzle therein;
forming a coupling portion integrally with one of the at least one stationary nozzle and the outer ring such that the coupling portion extends outwardly therefrom; and
coupling an attachment member to the coupling portion to facilitate substantially restricting movement of the at least one stationary nozzle when the outer ring is substantially distorted.

18. A method of assembling a rotary machine in accordance with claim 17, wherein coupling an attachment member further comprises coupling an attachment member that includes a pin configured to fixedly secure said at least one stationary nozzle to said outer ring.

19. A method of assembling a rotary machine in accordance with claim 18, wherein forming a coupling portion further comprises forming a coupling portion that includes an end portion including a substantially arcuate groove defined therein, the groove is configured to receive the pin therein.

20. A method of assembling a rotary machine in accordance with claim 17, wherein coupling an attachment member further comprises coupling an attachment member that includes a plate positioned between the at least one stationary nozzle and the outer ring.
